(19) United States
(12) Patent Application Publication
(10) Pub. No.: US 2007/0219832 A1
(43) Pub. Date: Sep. 20, 2007

(54) Travel profile access system and method

(75) Inventor: Louis Willacy, Oakland, CA (US)

Correspondence Address: FIDEL D. NWAMU, 761 HADDON PLACE, OAKLAND, CA, 94610, US

(73) Assignee: Interactive Travel Group, Inc.

(21) Appl. No.: 11/378,493

(22) Filed: Mar. 18, 2006

(51) Int. Cl. G06Q 10/00

(52) U.S. Cl. 705/5

(57) ABSTRACT

A universal travel profile access system and method. The system allows a user to create and store the user's travel profile for future retrieval. The user can then access the travel profile from one or more multiple travel reservation systems. The system includes a central database system coupled to one or more travel reservation systems selected by the user to process a travel arrangement. In one embodiment, the central database system and the one or more travel reservation systems are coupled via a distributed communication network such as the Internet. The central database system stores the travel profile and when the user provides authentication information, the one or more travel reservation systems forwards said authentication information to the central database system to retrieve the stored travel profile in order to complete the user's travel arrangement.

### BACKGROUND OF THE INVENTION

The present invention relates generally to travel, and travel reservation systems and methods and more specifically to travel, and travel reservation systems and methods for universal access to user travel profiles.

Consumer demand for travel and related services such as air, train and hotel reservations is rapidly increasing. One reason for the demand can be attributed to business globalization. Another reason is attributable to tourism and many travelers wish to expand their horizon.

With this increased demand, it is not uncommon for business executives to travel numerous times a year for business office visits or for business meetings. Vacation seekers are also traveling with increased frequency as well. For each trip, however, the intending passenger must make travel reservations for airlines, hotels, cars etc. typically via the Internet or over the telephone. That is, frequent travelers typically have to make numerous travel reservations commensurate with their travel plans.

For example, a business executive may desire to fly from New York to Italy on business. Assume that United Airlines is the preferred airline of choice. The business executive can proceed by booking an airline reservation via the Internet at www.united.com, for example. During the reservation process, a search is performed to create an itinerary i.e. departure and arrival dates and airports, in this case JFK and MXP (Milan). Once the itinerary is confirmed, passenger information is entered, followed by booking information. Booking information may include travel preferences and recurring information such as frequent flyer numbers, meals, special requests, credit card information, billing and delivery information. If the executive has a United Airlines frequent flyer number, that number may be entered as well.

The business executive may also wish to reserve appropriate lodging via a hotel reservation system (Marriott.com or bookitalyhotels.com, for example). Again, after a hotel is selected, reservation details including name, number of guests, credit card information, address, etc. are entered via a “Reservation Details” page. If the business executive has signed up for Marriott's frequent guest program, that number can be entered as well. This entire process is repeated if the business executive wishes to travel by train. Appropriate train reservations must be made.

Upon returning from Italy, the business executive may now desire to travel from New York to London via another airline (e.g. American Airlines). The reservation process is repeated this time for American Airlines at www.aa.com. During the reservation process, a search is performed to create an itinerary i.e. departure and arrival dates and airports in this case JFK and LHR (London). Once the itinerary is confirmed, passenger information is entered, followed by booking information and/or travel preferences. The American Airline frequent flyer number is then entered as well if the business executive is a frequent flyer member.

Assuming that this business executive travels 50 times, for example, among other disadvantages, the business executive must make 50 reservations and repeat the entire process and reenter previously entered information; for each trip and/or travel reservation, the business executive or an intending passenger must repeat and reenter all information in the aforementioned described manner. To the extent possible, all frequent flyer numbers, frequent guest numbers, etc. must also be reentered as well.

There is a need to address one or more of the foregoing disadvantages of conventional travel related systems and methods and the present invention meets this need.

### BRIEF SUMMARY OF THE INVENTION

Various aspects of a travel profile access system and method can be found in exemplary embodiments of the present invention. In a first embodiment, a method, by a central database system, for permitting access to a user's travel profile is disclosed. The travel profile is accessible via one or more travel reservation systems selected by the user to complete a travel arrangement. A travel profile might contain the user's name and the user's traveling preference, for example. A travel arrangement can either refer to the process of booking an airline trip, hotel, car, etc. or to an itinerary that includes travel information for the airline trip, hotel, car, etc. Not only can a travel arrangement include a single airline trip, it can include multiple airline trips and reservations for hotels, car, etc.

More specifically, according to the first embodiment of the present invention, the method comprises initially storing, by the central database system, the travel profile, which includes the user's name and traveling preference, and then assigning identification information to this travel profile to permit its future retrieval. This identification information may be a combination of a username/passcode that uniquely identifies the user.

After identification information is assigned to the stored travel profile, the method comprises, the central data system receiving a request from a first travel reservation system selected by the user to complete the travel arrangement. This first reservation system can be an airline reservation system accessed through the reservation system website by the user. Herein lies an advantage of the present invention. Unlike conventional methods, the user can select a desired travel reservation system to complete the travel arrangement.

After receiving the identification information, the method comprises the central database system authenticating the request by using this identification information to determine whether the first reservation system is authorized to receive the travel profile. If the first reservation system is authorized, the method comprises the central database system forwarding this stored travel profile to the first reservation system to process the travel arrangement for the user. In this manner, the present invention permits travel reservation systems to receive user travel profiles to complete and utilize information contained therein for travel arrangements, with need for only minimal information entry when a travel reservation is booked.

According to a further embodiment, the method of the first embodiment further comprises the user, selecting a second reservation system to complete the travel arrangement. This second reservation system might be a hotel reservation system, selected by the user via the hotel reservation system website, for example. Thus, if both airline and hotel reservations are needed, the user can employ the first (airline) reservation system to book an airline flight and the second (hotel) reservation system for a hotel room.

Next, the method comprises the second reservation system, forwarding a request to the central database system for the stored travel profile. The central database system then authenticates the request by using the identification information; and responsive thereof, forwards the stored travel profile to the second reservation system for processing of the travel arrangement.

In one aspect, the travel profile may include an airline frequent flyer number and a hotel frequent guest number. In an alternate aspect, the travel profile may include a flight change notification preference. Further yet, the travel profile can include multiple frequent flyer numbers for various airlines. In yet another aspect, the travel profile might include one or more media files. The media file may be a favorite photograph displayed on a television in a reserved hotel room to personalize the user's experience.

According to a third embodiment of the present invention a system that allows universal access to a user's travel profile from multiple travel reservation systems is disclosed. The system comprises one or more travel reservation systems selected by the user to process a travel arrangement for the user; and a central database system, coupled to the one or more travel reservation systems through a distributed communication network, the central database system for storing the travel profile.

The user provides authentication information to the one or more travel reservation systems to process the travel arrangement. In response, the travel reservation system provides the authentication information to the central database system in order to retrieve the stored travel profile to complete the travel arrangement for the user.

According to a fourth embodiment of the present invention, a system that allows universal access to a user's travel profile is disclosed. The system comprises: (1) one or more means for booking travel reservations, selected by the user to process a travel arrangement for the user; and (2) a central means for storage, coupled to the means for booking travel reservations through a distributed communication network, the central means for storage for storing the travel profile.

The user provides authentication information to the means for booking travel reservations so that the travel arrangement can be processed. In response, the means for booking travel reservations then provides the authentication information to the central means for storage in order to retrieve the stored travel profile for use in completing the travel arrangement for the user.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 is a network diagram of a traveler identification system 100 for universal access to travel profiles in accordance with an exemplary embodiment of the present invention.

FIG. 2 is an alternate simplified network diagram of a TID system 200 in accordance with an exemplary embodiment of the present invention.

FIG. 3A is a flow chart of a method 300 of the present invention in accordance with an exemplary embodiment of the present invention.

FIG. 3B shows an “account profile” form 320 according to an exemplary embodiment of the present invention.

FIG. 3C shows an “account profile” form 340 according to an exemplary embodiment of the present invention.

FIG. 3D shows an “account profile” form 360 according to an exemplary embodiment of the present invention.

FIG. 3E shows a “travel preferences” form 380 in accordance with an exemplary embodiment of the present invention.

FIG. 3F shows a “travel preferences” form 350 according to an exemplary embodiment of the present invention.

FIG. 3G shows a “travel preferences” form 370 in accordance with an exemplary embodiment of the present invention.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

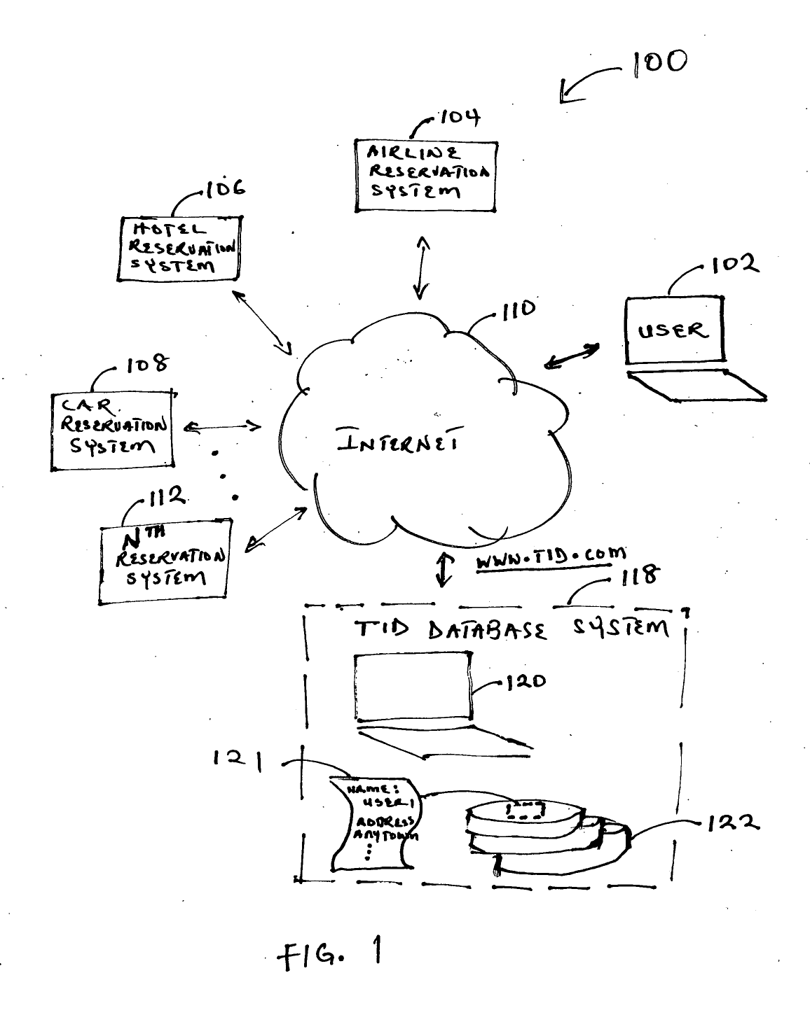

FIG. 1 is a network diagram of a traveler identification system 100 for universal access to travel profiles in accordance with an exemplary embodiment of the present invention.

In FIG. 1, among other components, traveler identification (TID) system 100 comprises user 102 communicably linked to airline reservation system 104 via Internet 110. User 102 is further connected to hotel reservation system 106 and car reservation system 108 and N^{TH} reservation system 112 also via Internet 110. Although not shown, Internet 110 represents any distributed network (wireless, wired, e.g., RS232) for data transmission and receipt between two points.

User 102 can access airline reservation system 104 via Internet 110 for travel reservations. Airline reservation system 104 in this example is accessible via its associated travel website. Searchable flight schedules are available on the website and user 102 can search and book specific flights for airline travel. The same goes for hotel reservation system 106 through which user 102 can reserve a room, and car reservation system 108 through which a rental car can be reserved. User 102 can also access N^{TH} reservation system 112 to book travel reservations. Here, N^{TH} reservation system 112 may represent additional travel reservation systems e.g., airline, hotel, car, etc.

Although shown as a computing device in FIG. 1, user 102 also refers to a passenger or traveler that uses said computing device for travel reservations. The computing device may be a personal computer, telephone, wireless device or the like. The computer itself can be of varying types including laptop, notebook, palm-top, pen-top, etc., and may not resemble the computer of FIG. 1 as in the case where a processor is embedded into another device or appliance such as an automobile or a cellular telephone. Because of the ever-changing nature of computers and networks, the description of hardware in this specification is intended only by way of example for the purpose of illustrating the embodiment.

Although not necessary, each reservation system 104, 106, 108, 112 is preferably well known and preexisting, having an existing customer base. Airline reservation system 104 in this example can be the well known United Airlines reservation system and its associated website www.united.com. Hotel reservation system 106 may represent the Marriott reservation system (www.marriott.com) while car reservation system 108 might represent Budget car rental reservation system. Likewise, depending on what N^{TH} reservation system 112 represents, it may be the American Airlines reservation system (www.aa.com) or the Bookitalyhotels.com reservation system or the Avis car reservation system, for example. These are of course exemplary and one of ordinary skill in the art will understand that other existing reservation systems and types within this invention's scope can be utilized.

Each reservation system 104, 106, 108, 112 is also independent in that no communication exchange occurs between the reservation systems. Preferably, each reservation system runs a different computer operating system. For example, airline reservation system 104 may run Windows, while hotel reservation system 104 might run a UNIX platform. In this manner, the present invention can provide a single and seamless interface for receiving information from various computing environments.

In FIG. 1, TID system 100 further comprises TID database system 118 communicably coupled to Internet 110. Thus, user 102 can access TID database system 118 via www.travelerid.com, a proprietary website associated with the present invention. This website is hosted by dedicated server 120 of TID database system 118. TID database system 118 can be considered a content management system and repository for data. TID database system 118 may include both relational and object XML data stores (not shown). TID database system 118 can provide for storage, viewing, importing, organizing, modifying, exporting, and query travel-related information.

Upon accessing www.travelerid.com, user 102 can create a travel profile 121 for storage on storage device 122. A travel profile is an information file specific to a traveler. In one embodiment, the information file includes only data such as a traveler name (or other identifier), and traveling preferences such as airline “window seating” and other recurring and nonrecurring information. In an alternate embodiment, the information file includes both data and media content such as videos, photographs, music, etc.

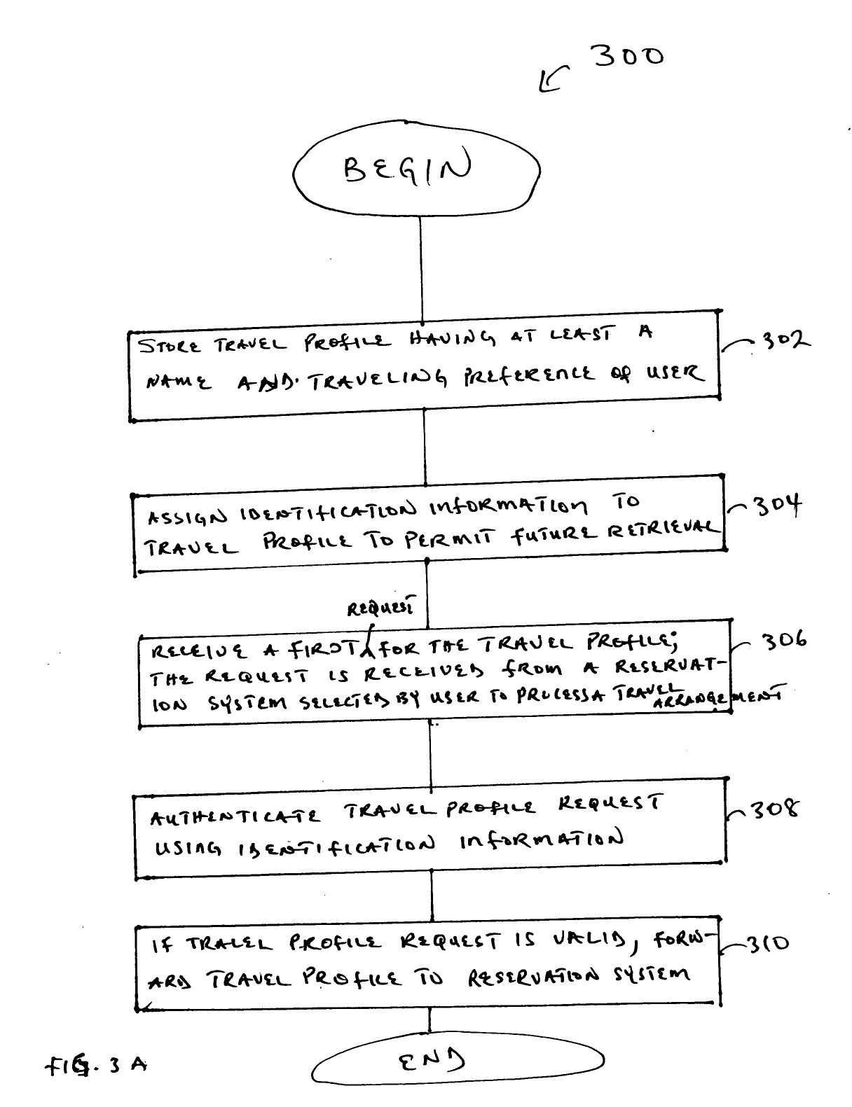

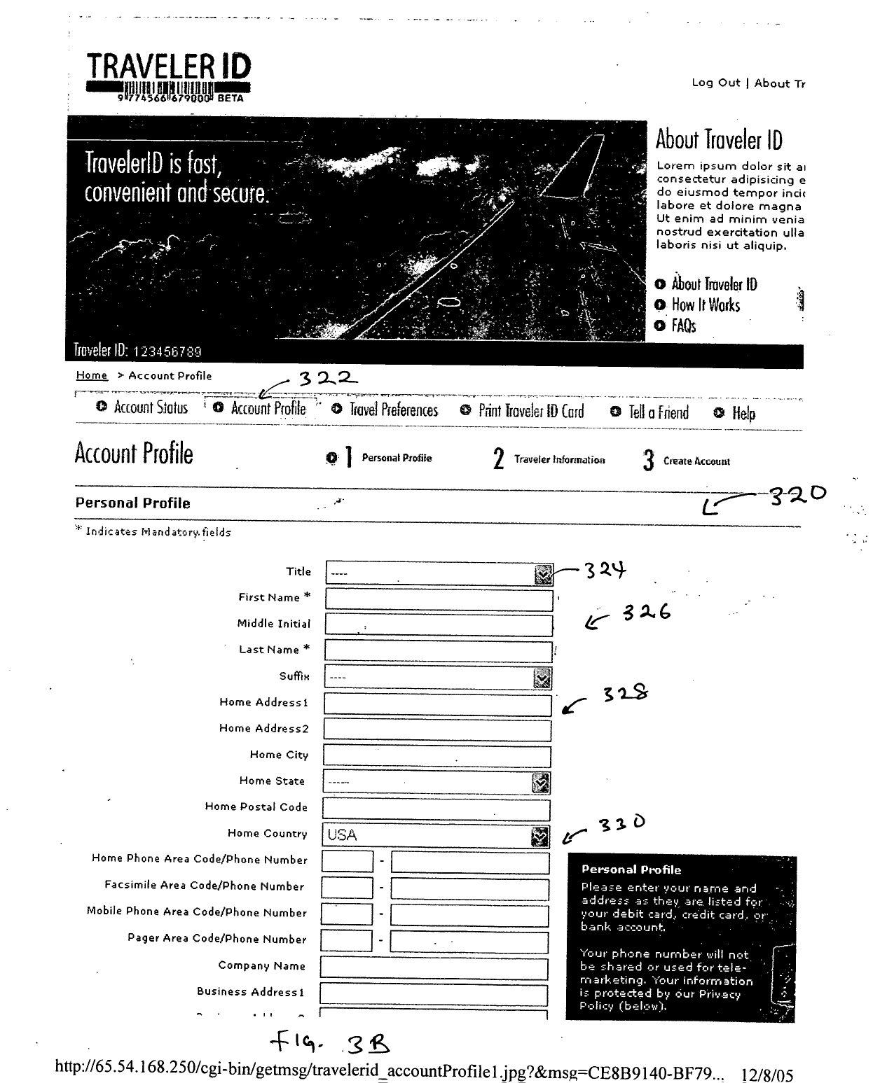

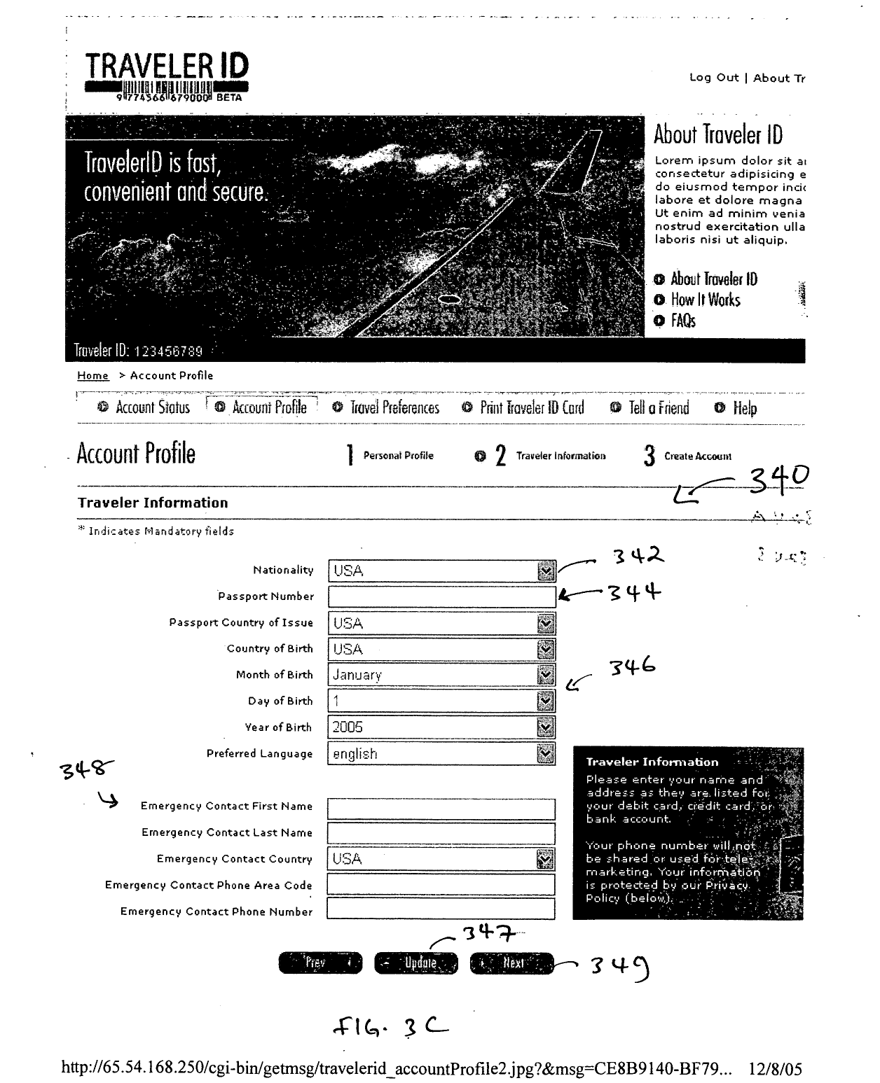

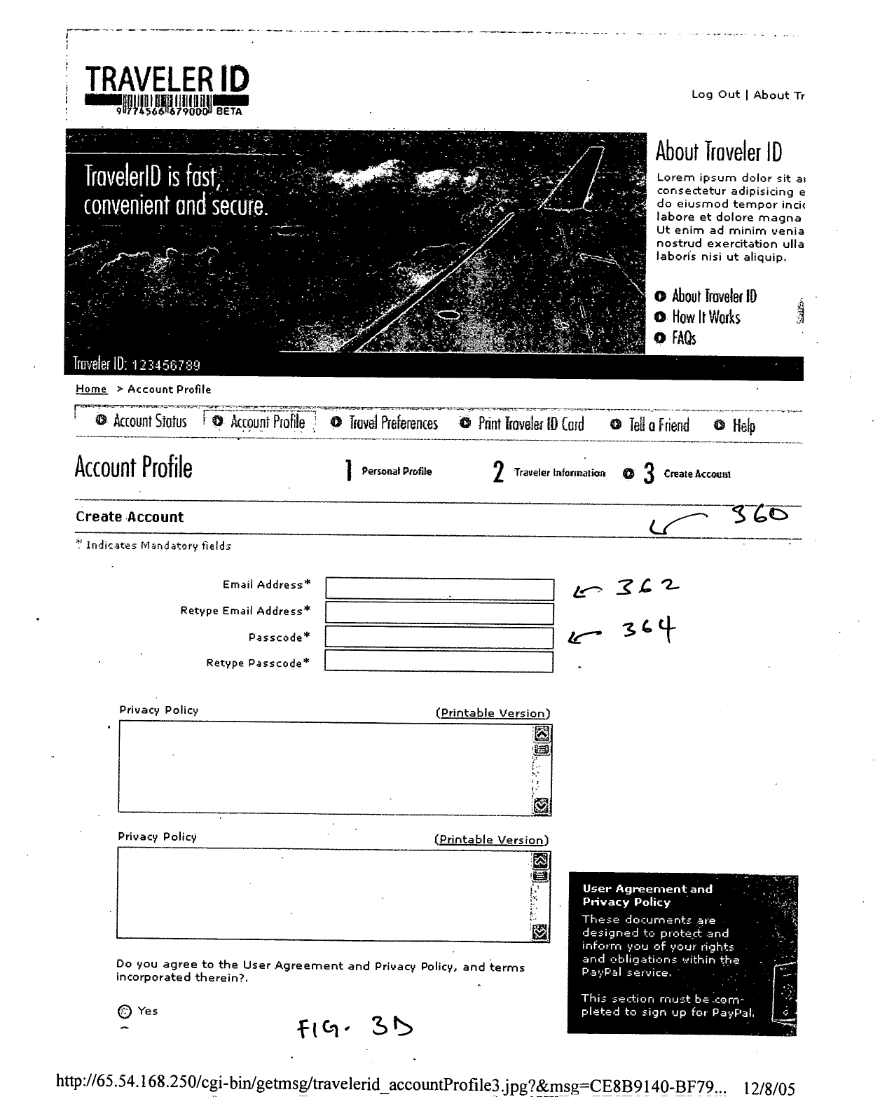

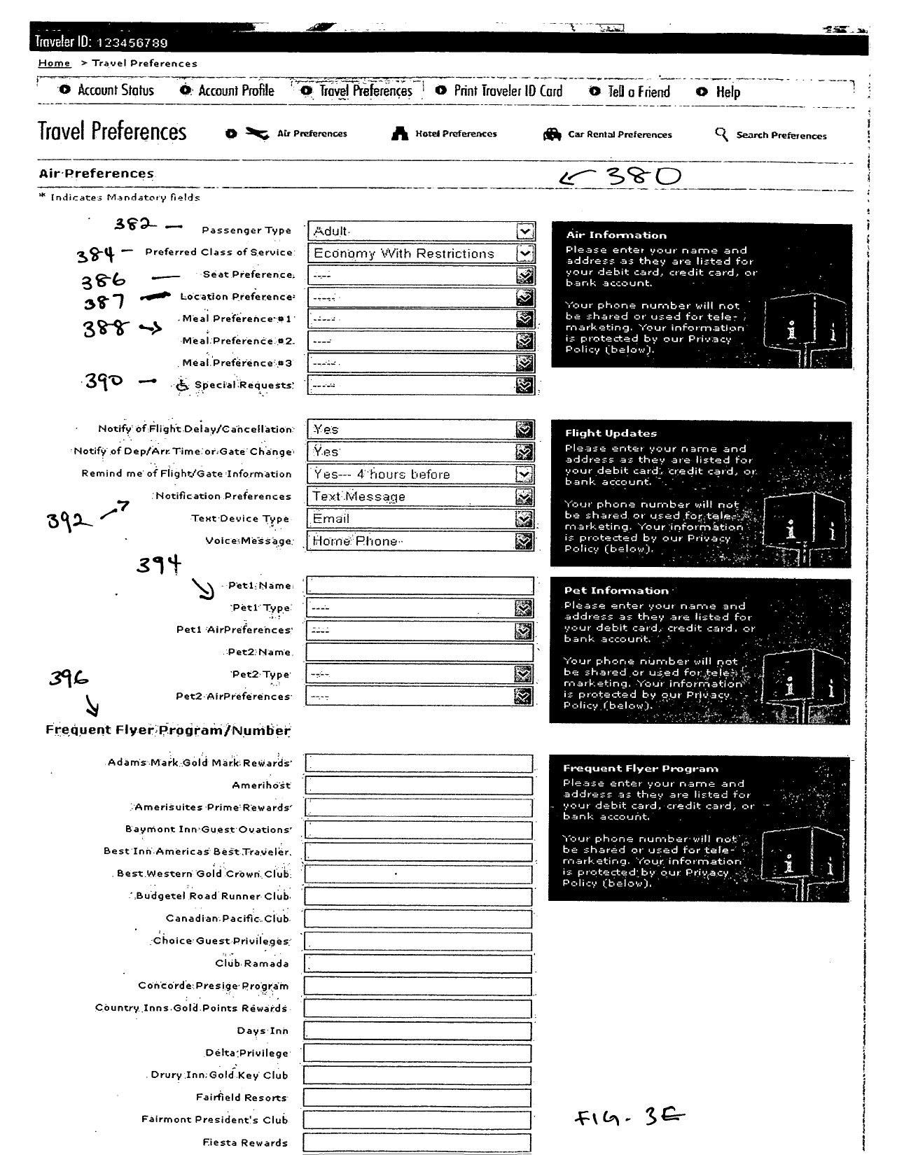

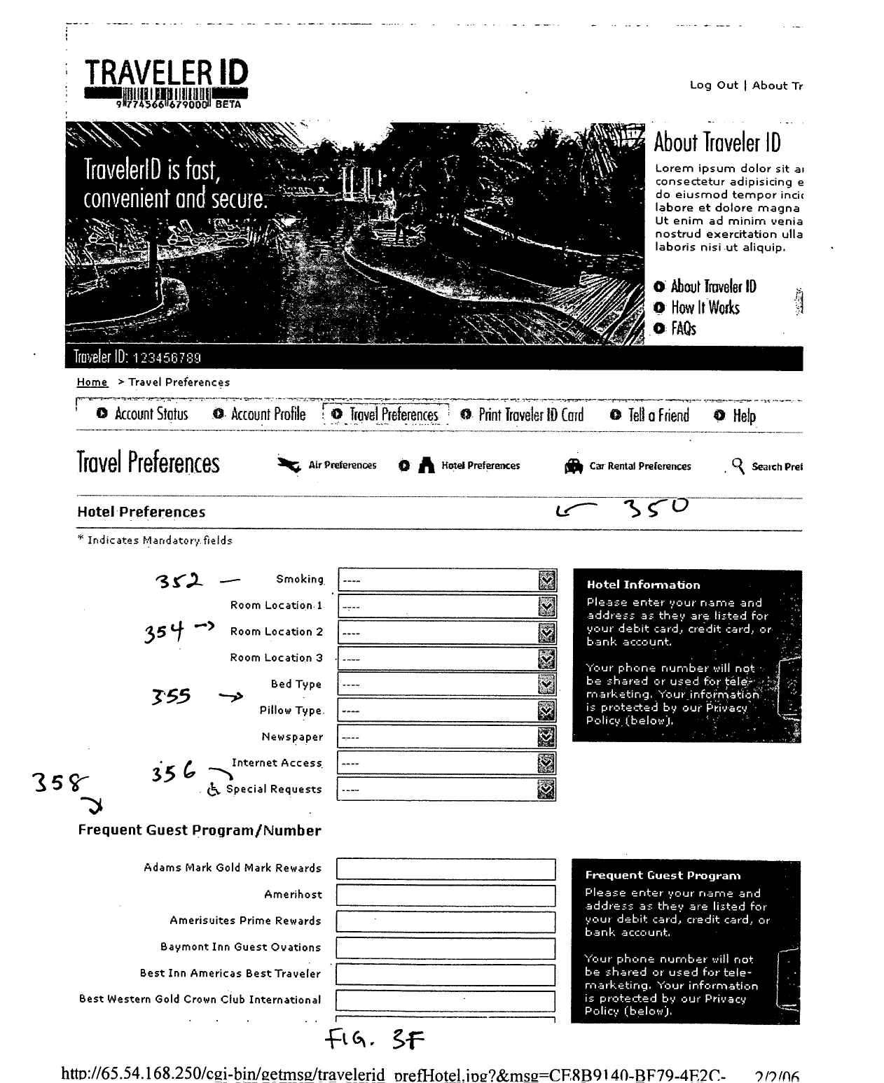

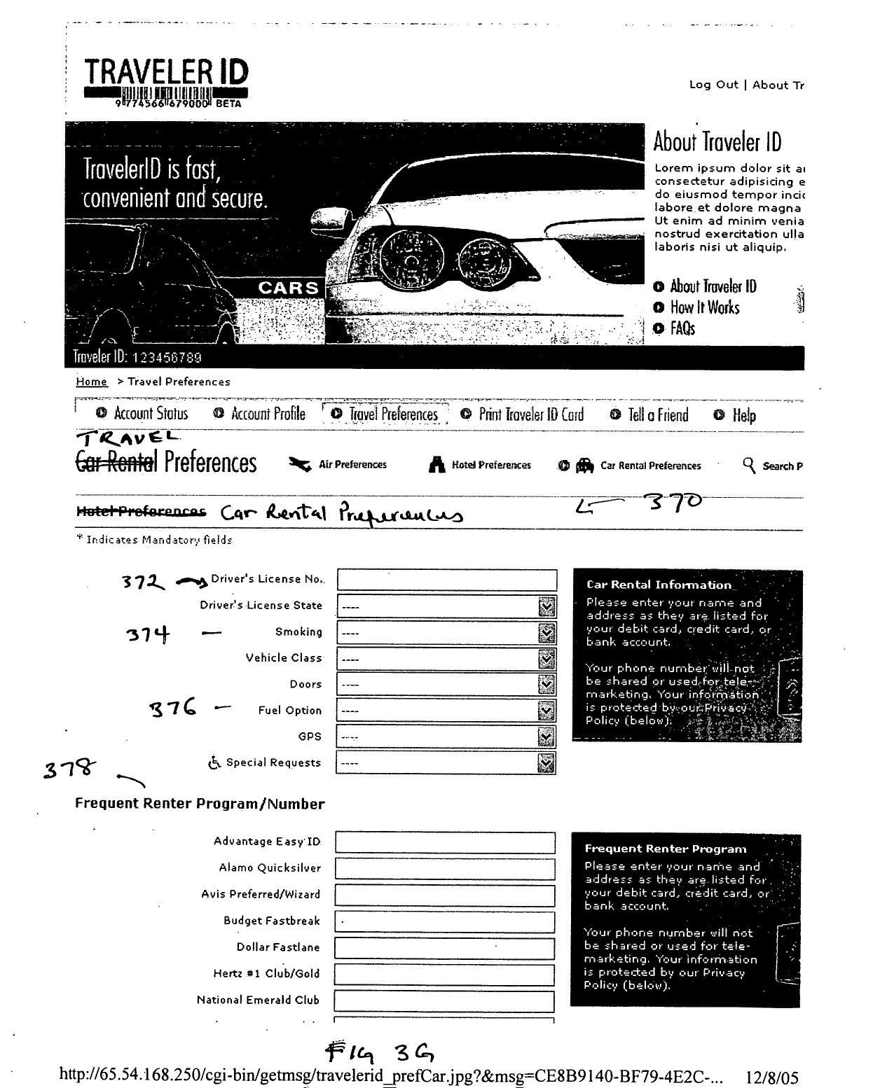

In operation, user 102 begins by registering with TID database system 118. More specifically, user 102 logs on to www.travelerid.com to enter personal and user preference information into various data entry forms presented by dedicated server 120. The collected information is saved and used to create travel profile 121. TID database 118 then assigns a uniquely identifiable traveler Identification (ID) number and passcode to travel profile 121. This traveler ID can then be employed by user 102 for future retrieval of travel profile 121. The registration process and screen shots for exemplary data entry forms are further described with reference to FIGS. 3A-3G, below.

After storage, travel profile 121 is now retrievable to complete travel reservations. In this manner, the present invention avoids the time-consuming task of entering every and all information when travel reservations are booked. Rather, user information is simply obtained from travel profile 121. Now, assume that either shortly after or contemporaneous with registration that user 102 wishes to travel to Italy. User 102 would visit airline reservation system 104's website (e.g., www.united.com) for travel reservations. User 102 is able to conduct normal flight searches using airline reservation system 104. User 102 is further able to retrieve travel profile 121 from TID database 118 to complete such reservations. At a “reservation details” web page, user 102 enters the traveler ID number and passcode and thereafter clicks a “Submit” button on the page, which transmits this traveler ID number and passcode from airline reservation system 104 to TID database system 118.

If user 102 correctly enters this information, TID database system 118 authenticates the traveler ID number and passcode. After authentication, travel profile 121 is then forwarded to airline reservation system 104. In one embodiment, data contained therein is used to automatically populate selected fields of the reservation to complete the travel reservation. In an alternate embodiment, the profile is simply forwarded to airline reservation system 104, which then determines how best to utilize the information. Note that as with airline reservation system 104, travel profile 121 can also be retrieved through hotel reservation 106 and car reservation system 108 for reservations. After the airline reservation is completed, user 102 can employ the same procedure for hotel and car reservations through hotel reservation system 106 and car reservation system 108, respectively.

An advantage thereof of the present invention is that stored user preference profiles can be retrieved to complete travel reservations without the need for abundant information entry. Further yet, another advantage of the present invention is that integration between the present invention and existing reservation systems is seamless such that user traveler profiles can be retrieved without interruption to existing booking reservation processes. Yet, preference information contained in travel profile 121 is comprehensive. Additional information (e.g. hotel room preferences) not typically requested by existing reservation systems is automatically forwarded to reservation systems, providing more information on their customers.

If user 102 has not previously registered and has no traveler ID number, user 102 can register normally without travel profile 121. After the reservation is made, a reservation confirmation email from airline reservation system 104 is sent to the user 102. The confirmation email contains a prompt requesting user 102 to register for a traveler ID number. The prompt uses a specific link that includes a company ID number, provider ID number and an itinerary number.

A company ID is assigned by TID database 118 for uniquely identifying a company travel service provider. For example, Marriott, the hotel chain might have a “1000” company ID number. A provider number is further used to identify particular locations or specific service providers of a company travel service provider. For example, Marriott San Francisco might be assigned a “10” while Marriott New York is assigned a “20”. Thus, the email link to user 102 after booking a reservation for Marriott San Francisco, for example, might resemble the following:

www.travelerid.com company ID=“1000” provider ID=“10” itinerary number=“123459.”

If user 102 initiates TID registration (by clicking on the email link), the company ID, provider ID and itinerary number fields are automatically captured into a newly created TID account for user 102. Once the travel profile is created, an optional “Submit” button that allows user 102 to send this travel profile to airline reservation system 104 is displayed. If user 102 agrees to submit, the new travel profile is appended to user 102's travel itinerary and then sent back to airline reservation system 104. In this manner, the present invention integrates seamlessly with existing travel reservation systems by allowing member registration without interrupting the normal travel reservation process.

In summary, a universal travel profile access system and method is disclosed. The system allows a user to create and store the user's travel profile for future retrieval. The user can then access the travel profile from one or more multiple travel reservation systems. The system includes a central database system coupled to one or more travel reservation systems selected by the user to process a travel arrangement. In one embodiment, the central database system and the one or more travel reservation systems are coupled via a distributed communication network such as the Internet. The central database system stores the travel profile and when the user provides authentication information, the one or more travel reservation systems forwards said authentication information to the central database system to retrieve the stored travel profile in order to complete the user's travel arrangement.

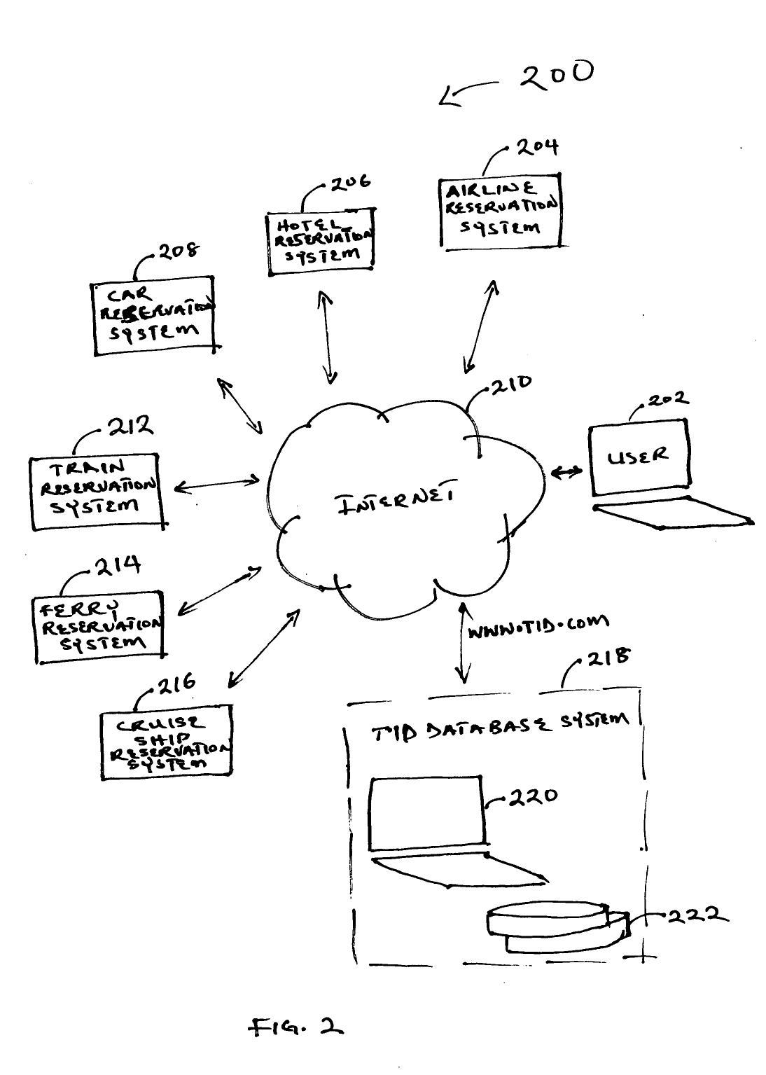

FIG. 2 is an alternate simplified network diagram of a TID system 200 in accordance with an exemplary embodiment of the present invention.

In FIG. 2, user 202 is coupled to airline reservation system 204, hotel reservation system 206 and car reservation system 208 via the Internet 210 as in FIG. 1. In addition, user 202 can access train reservation system 212 for booking train reservations and ferry reservation system 214 for ferry reservations, and cruise ship reservation system 216 for cruise ship reservations. One of ordinary skill will understand that the shown reservation systems are exemplary, and that although not shown, additional reservation systems are contemplated for inclusion in TID system 200. For example, a resort reservation system can also be incorporated in TID system 200. In use, user 202 can employ any of the shown reservation systems for access to TID database system 218 as similarly described with reference to FIG. 1.

FIG. 3A is a flow chart for a method 300 in accordance with an exemplary embodiment of the present invention.

Briefly and referring to FIG. 1, method 300 implemented by TID database system 118 permits access to user 102's travel profile stored by storage device 122. The travel profile is accessible via one or more reservation systems 104, 106, 108, 112 selected by user 102 to complete a travel arrangement.

Among other steps, method 300 comprises initially employing TID database system 118 to store travel profile 121 (FIG. 1) having at least a user name and traveling preference of user 102. Next, identification information is assigned to travel profile 121, which is then stored by storage device 122 for future retrieval. A request for the stored travel profile is then received from airline reservation system 104 selected by user 102 to complete a travel arrangement. TID database system 118 authenticates the request by using the previously assigned identification information, and responsive thereof, stored travel profile 121 is forwarded from TID database system 118 to airline reservation system 104 for processing of the travel arrangement.

In more detail, at step 302, method 300 comprises storing, by TID database system 118, the travel profile 121 having at least user 102's name and traveling preference. Specifically, assume that user 102 intends to travel to Italy, and has heard, via advertising or otherwise, about TID database system 118 and its various functionalities, e.g., ability to store travel profiles. First, user 102 begins by logging on to TID database system 118 via “www.travelerid.com” hosted by server 120. Once logged on, user 102 then steps through various web pages (data forms) to enter personal profile data and travel preferences. It is this information that is then saved as travel profile 121. To enhance understanding of the type of information contained therein in travel profile 121, screen shots for various data forms showing the collected information are now described with reference to FIGS. 3B-3G, below. In a first embodiment, the data forms include text-based-forms or other data-entry fields, which can be filled by user 102 with the desired information. Alternatively, the forms may be a visual configuration page showing selectable options or drop down menus.

FIG. 3B shows an “account profile” form 320 according to an exemplary embodiment of the present invention.

In FIG. 3B, “account profile” form 320 is the initial form displayed to user 102 at “www.travelerid.com.” Specifically, user 102 employs “account profile” form 320 to enter personal data for a traveler ID account. Personal data can be entered via text or drop down menus into various data fields. As shown, drop down menu 324 allows user 102 to select a title while data fields 326 enable user 102 to specify a name. Data fields 328 are for address information and data fields 330 allow user 102 to specify phone number information. Although not discussed, various other data fields are shown. Each data field has an identifier that indicates the information requested from user 102. Once all fields are completed, user 102 selects a next button (not shown) to display an “account profile” form 340 (FIG. 3C). It should be apparent that the options for any of the data fields and drop down menus above can be modified so that more, less, or different options can be specified.

As can be seen, and as it will become more apparent, user data requested for entry in these data forms is comprehensive. Herein lies one advantage of the present invention. Since comprehensive user data is collected, more tailored products and services can be offered to user 102.

FIG. 3C shows “account profile” form 340 according to an exemplary embodiment of the present invention.

In FIG. 3C, “account profile” form 340 enables user 102 to enter personal travel information. As shown, personal travel information includes nationality information selectable from drop down menu 342, a passport number specifiable in data field 344 and a birth date selectable from drop down menu 346. User 102 can also enter emergency contact information in data fields 348, and if any previously entered information needs updating, user 102 can click an “update” button 347. Upon completion of data entry, user 102 clicks a “next” button 349 to display an “account profile” form 360 (FIG. 3D).

FIG. 3D shows “account profile” form 360 according to an exemplary embodiment of the present invention.

In FIG. 3D, “account profile” 360 allows user 102 to create a user account. As shown, user 102 can specify an email address in data field 362 and a corresponding passcode in data field 364. User 102 thereafter clicks on a “create account” button (not shown) to create a user account. Although user 102's account profile is now active, travel preferences namely air, hotel and car rental preferences ought to be specified. Screen shots for air, hotel and car rental preferences are discussed with respect to FIGS. 3E-3F.

FIG. 3E shows “travel preferences” form 380 in accordance with an exemplary embodiment of the present invention.

In FIG. 3E, “travel preferences” form 380 permits user 102 to enter air travel preference information. User 102 may select a passenger type e.g., Adult or Child, from drop down menu 382 and may also select a preferred service class from drop down menu 384. In this example, user 102 has selected “Adult” as passenger type and “Economy With Restrictions” as the preferred service class. Other drop down menus selectable by user 102 are “seat preference” 386 e.g., aisle or window seats and “location preference” 387, e.g., front of cabin, rear of cabin, emergency row exit. Additional fields are meal preferences 388 e.g., vegetarian or kosher, “special requests” 390, e.g., wheelchair accessibility needed, and flight information 392 e.g., notify user of flight delay/cancellation. If user 102 has a pet, the pet's name and air preference can be entered in data field 394. Air preference options for pets may be “in cabin” or “in baggage compartment.”

A unique aspect of the present invention is that multiple airline frequent flyer numbers for user 102 can be specified in data fields 396. Frequent travelers typically have many frequent flyer programs/numbers that are particularly difficult to track. With the present invention, frequent flyer numbers can be saved for future retrieval by travel reservation systems selected by user 102. In FIG. 3E, exemplary frequent flyer programs are shown. It is apparent that the frequent flyer programs of FIG. 3E are non-exhaustive, and additions and substitutions can be made by one skilled in the arts.

FIG. 3F shows “travel preferences” form 350 according to an exemplary embodiment of the present invention.

In FIG. 3F, travel preference form 350 allows user 102 to enter hotel preferences. In particular, user 102 may select either a smoking or nonsmoking room from drop down menu 352, and might specify an “ocean view” room using drop down menu 354. In fact, user 102 may further specify “bed type”, “pillow type”, “newspaper”, “Internet access” and “special requests” using the appropriate drop down menus. An example of “pillow type” selection is hypo-allergenic or non hypo-allergenic.

Another unique aspect of the present invention is that user 102 can choose to specify and store multiple hotel frequent guest numbers in data fields 358. As with frequent flyer numbers, it is difficult for many travelers to track their numerous hotel frequent guest numbers. With the present invention, frequent guest numbers can be saved for future retrieval by travel reservation systems selected by user 102. In FIG. 3F, exemplary frequent guest programs are shown. It is apparent that the guest programs of FIG. 3F are non-exhaustive and additions and substitutions can be made by one skilled in the arts.

FIG. 3G shows a “travel preferences” form 370 in accordance with an exemplary embodiment of the present invention.

In FIG. 3G, “travel preferences” form 370 permits user 102 to enter car rental preferences. User 102 specifies driving license information in data field 372 and selection of smoking or nonsmoking in drop down menu 374. The capability for selection of a “vehicle class”, “no. of doors”, “GPS” and “special requests” is also provided to user 102. If user 102 further prefers a full tank option, that preference is specified in drop down menu 376.

A further advantage of the present invention is that user 102 can choose to specify and store multiple frequent renter numbers in data fields 378. As with frequent flyer numbers, it is difficult for many travelers to track their frequent renter numbers for the various car rental companies. With the present invention, frequent renter numbers can be saved for future retrieval by travel reservation systems selected by user 102. In FIG. 3G, exemplary frequent renter programs are shown. It is apparent that the guest programs of FIG. 3G are non-exhaustive and additions and substitutions are thus possible. At this point, all information requested for air, hotel and car rental preferences have been entered. User 102 now clicks a “next” button to store the travel profile and complete the user registration process.

As another advantage, the present invention allows providers e.g. airline reservation system 104 to update user travel profiles after they are created. Since providers may receive user information not previously provided to TID database system 118, this allows additional information to be added to travel profiles.

Returning now to FIG. 3B, after travel profile 121 is stored, at step 304, method 300 comprises assigning identification information to travel profile 121 to permit its future retrieval. In one embodiment, the identification information is a Traveler Identification number that uniquely identifies user 102 for authentication purposes. In an alternate embodiment, the identification information is a uniquely identifiable alphanumeric character string and corresponding passcode assigned to user 102. At this point, travel profile 121 is now stored and identification information allowing retrieval of this profile has been assigned by TID database system 118.

Assume that shortly after the preceding steps, user 102 desires wishes to process a travel arrangement, i.e., book a travel reservation. User 102 would visit airline reservation system 104's website (e.g., www.united.com) for travel reservations. Herein lies an advantage of the present invention. In conventional systems, the user logs on to a third party website portal, which then books a reservation on any airline selected by that portal. Unlike conventional systems, however, user 102 has the ability to choose which airlines to book reservations for. Thus, say user 102 prefers flying United Airlines, then that airline can be selected by visiting United's website and booking a reservation. If user 102 prefers Continental, then that airline can be selected as well. In this manner, the present invention is able to maintain user flexibility to choose different reservation systems. Of course, reservations systems for these airlines are communicably linked to TID database system 118.

At step 306, after identification information is assigned to stored travel profile 121, method 300 includes receiving a request from airline reservation system 104 for stored travel profile 121. The request is accompanied by the identification information, which is provided by user 102 while booking a travel arrangement through airline reservation system 104. In particular, intending to book the travel arrangement, user 102 logs on to airline reservation system 104's website, and conducts “normal flight searches” to select a desired flight itinerary. By “normal flight searches,” it is meant that user 102 simply conducts a search as one would normally do without the present invention at a travel reservation website, for example. After the desired flight itinerary is selected, user 102 enters the assigned identification information (and password) and thereafter clicks a “Submit” button. This action then causes airline reservation system 104 to transmit the identification information/passcode along with the request for travel profile 121 to TID database system 118. Here, it should be observed that, unlike conventional systems, user 102 first provides the identification information to airline reservation system 104 (or whichever reservation system is processing the travel arrangement), and then airline reservation system 104 forwards the identification information to TID database system 118 for the travel profile request.

At step 308, method 300 involves authenticating the request for travel profile 121 by using the identification information to determine whether the airline reservation system 104 is authorized to receive travel profile 121.

At step 310, if airline reservation system 104 is authorized, responsive thereof, method 300 involves forwarding the stored travel profile 121 to airline reservation system 104 for use in processing the travel arrangement. In one embodiment, data contained in travel profile 121 may be used to automatically populate selected travel reservation fields to complete the travel reservation. In an alternate embodiment, travel profile 121 is simply forwarded to airline reservation system 104, which then determines how best to utilize the information. While the above is a complete description of exemplary specific embodiments of the invention, additional embodiments are also possible. Thus, the above description should not be taken as limiting the scope of the invention, which is defined by the appended claims along with their full scope of equivalents.

I claim:

1. A system that allows universal access to a user's travel profile from multiple travel reservation systems, the travel profile having at least a name and a traveling preference of the user, the system comprising:
one or more travel reservation systems selected by the user to process a travel arrangement for the user; and
a central database system, coupled to the one or more travel reservation systems through a distributed communication network, the central database system for storing the travel profile, wherein the user provides authentication information to the one or more travel reservation systems to process the travel arrangement, and
responsive thereof, the one or more travel reservation systems provides said authentication information to the central database system in order to retrieve the stored travel profile to complete the travel arrangement for the user.

2. The system of claim 1 wherein the travel profile includes one or more media files.

3. A method by a central database system for permitting access to a user's travel profile, wherein the travel profile is accessible via one or more travel reservation systems selected to complete a travel arrangement for the user, the method comprising:
storing by the central database system the travel profile having at least a name and traveling preference of the user;
assigning identification information to the travel profile to permit future retrieval of the travel profile;
receiving, from a first reservation system selected by the user to complete the travel arrangement, a first request for the travel profile;
authenticating the request by using the identification information to determine whether the first reservation system is authorized to receive the travel profile; and
if so, responsive thereof, forwarding the stored travel profile to the first reservation system to process the travel arrangement for the user.

4. The method of claim 3 further comprising:
selecting, by the user, a second reservation system to complete the travel arrangement;
forwarding, by the second reservation system, a second request for the stored travel profile;
authenticating, by the central database, the second request by using the identification information; and
responsive thereof, forwarding the stored travel profile to the second reservation system for processing of the travel arrangement.

5. The method of claim 3 wherein the first reservation system is an airline reservation system, selected by the user via the airline's booking website.

6. The method of claim 4 wherein the second reservation system is a hotel reservation system, selected by the user via the hotel's booking website.

7. The method of claim 5 wherein the airline reservation system is running under a Windows platform.

8. The method of claim 6 wherein the hotel reservation system is running under a UNIX platform.

9. The method of claim 3 wherein the travel profile includes an airline frequent flyer number and a hotel frequent guest number.

10. The method of claim 3 wherein the travel profile includes a flight change notification preference.

11. The method of claim 3 wherein the travel profile includes multiple frequent flyer numbers for various airlines.

12. The method of claim 3 wherein the travel profile includes one or more media files.

13. The method of claim 12 wherein the media file is a favorite photograph, and wherein the favorite photograph is displayed on a television in a reserved hotel room to personalize the user's experience.

14. The method of claim 4 further comprising storing multiple itineraries or travel arrangements processed on behalf of the user by the first and second reservation systems.

15. A system that allows universal access to a user's travel profile, the travel profile having at least a name and a traveling preference of the user, the system comprising:
one or more means for booking travel reservations, selected by the user to process a travel arrangement for the user; and
a central means for storage, coupled to the one or more means for booking travel reservations, through a distributed communication network, the central means for storage for storing the travel profile, wherein the user provides authentication information to the one or more means for booking travel reservations to process the travel arrangement, and
responsive thereof, wherein the one or more means for booking travel reservations provide said authentication information to the central means for storage in order to retrieve the stored travel profile to complete the travel arrangement for the user.

16. The system of claim 15 wherein the travel profile includes one or more media files.
